(19) United States
(12) Patent Application Publication
(10) Pub. No.: US 2015/0193620 A1
(43) Pub. Date: Jul. 9, 2015

(54) System and Method for Managing UEFI Secure Boot Certificates

(71) Applicant: Dell Products, LP, Round Rock, TX (US)

(72) Inventors: Mukund P. Khatri, Austin, TX (US); Wei Liu, Austin, TX (US); Charles E. Rose, Nashua, NH (US); Sumanth Vidyadhara, Bangalore (IN)

(73) Assignee: Dell Products, LP, Round Rock, TX (US)

(21) Appl. No.: 14/149,366

(22) Filed: Jan. 7, 2014

(51) Int. Cl. G06F 21/57; G06F 12/00

(52) U.S. Cl. CPC G06F 21/575; G06F 12/00

(57) ABSTRACT

A service processor of an information handling system receives a Secure Boot database from a provisioning server coupled to the service processor by a data communication network. The Secure Boot database is stored at a memory device included at the service processor. The Secure Boot database is provided to a basic input output system (BIOS) at the information handling system in response to a request issued by intrinsic BIOS instructions executed during initialization of the information handling system.

### FIELD OF THE DISCLOSURE

This disclosure generally relates to information handling systems, and more particularly relates to managing UEFI secure boot certificates.

### BACKGROUND

As the value and use of information continues to increase, individuals and businesses seek additional ways to process and store information. One option is an information handling system. An information handling system generally processes, compiles, stores, and/or communicates information or data for business, personal, or other purposes. Because technology and information handling needs and requirements may vary between different applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems. Today, an enterprise may utilize information handling systems that include a large number of individual computers known as servers. Administration of large systems of servers can be a complex task.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 is a block diagram illustrating an information handling system according to an embodiment of the present disclosure;

FIG. 2 is a flow diagram illustrating a method for provisioning Secure Boot keys and certificates to an information handling system according to a specific embodiment of the present disclosure;

FIG. 3 shows an information handling system according to another embodiment of the present disclosure;

FIG. 4 is a flow diagram illustrating a method for provisioning Secure Boot keys and certificates to an information handling system according to another embodiment of the present disclosure;

FIG. 5 shows an information handling system according to still another embodiment of the present disclosure;

FIG. 6 is a flow diagram illustrating a method for provisioning Secure Boot keys and certificates to an information handling system according to still another embodiment of the present disclosure; and

FIG. 7 is a block diagram of an information handling system according to an embodiment of the present disclosure.

The use of the same reference symbols in different drawings indicates similar or identical items.

### DETAILED DESCRIPTION OF DRAWINGS

The following description in combination with the Figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings. However, other teachings may be utilized in this application, as well as in other applications and with several different types of architectures such as distributed computing architectures, client or server architectures, or middleware server architectures and associated components.

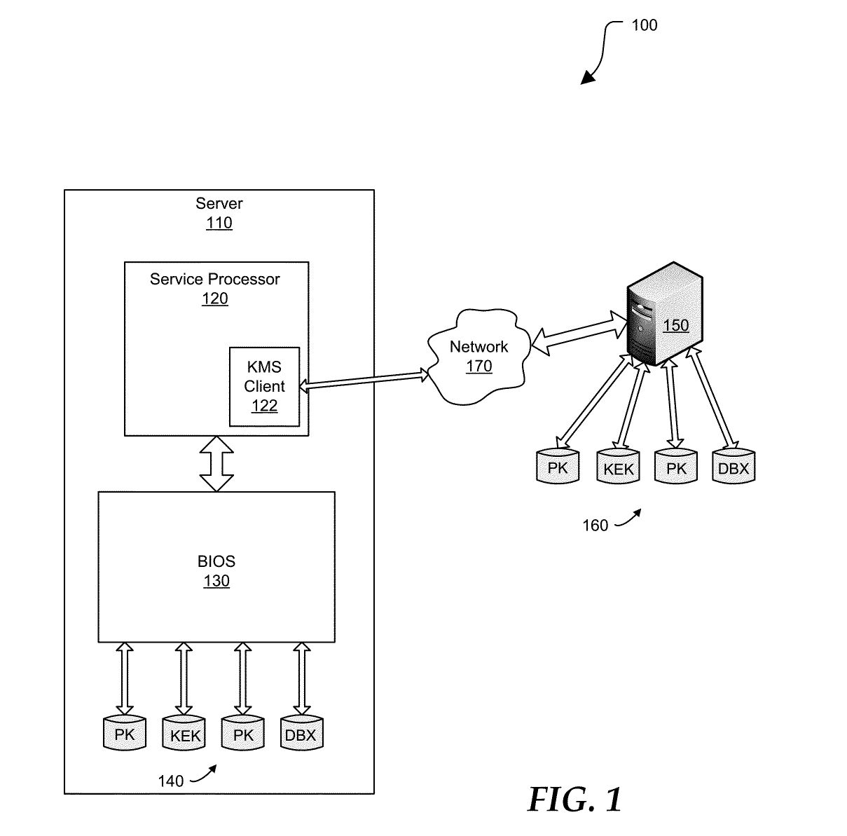

The Unified Extensible Firmware Interface (UEFI) includes a feature known as Secure Boot, which provides a mechanism for authenticating drivers and loaders that can be installed during boot initialization of an information handling system. FIGS. 1-7 illustrate techniques for managing and provisioning Secure Boot certificates and keys at a data center environment. As disclosed herein, Secure Boot signature databases and keys are maintained at a centralized provisioning or key management server. In one embodiment, the key management server can communicate Secure Boot certificates and keys to individual servers using out-of-band protocols. For example, a centralized key management server can provide the Secure Boot information to a service processor that is included at each host server at a data center. At boot time, each host server can access the Secure Boot information from the local service processor. In another embodiment, a host server can request the Secure Boot information from the centralized key management server during the boot process.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a PDA, a consumer electronic device, a network server or storage device, a switch router, wireless router, or other network communication device, or any other suitable device and may vary in size, shape, performance, functionality, and price. The information handling system may include memory, one or more processing resources such as a central processing unit (CPU) or hardware or software control logic. Additional components of the information handling system may include one or more storage devices, one or more communications ports for communicating with external devices as well as various input and output (I/O) devices, such as a keyboard, a mouse, and a video display. The information handling system may also include one or more buses operable to transmit communications between the various hardware components.

The Secure Boot protocol provided by the UEFI specification is configured to prevent the loading of UEFI drivers and operating system (OS) loaders that are not signed with an acceptable digital signature. Secure Boot does this by maintaining databases of software signers and software images that are pre-approved to run on a computer, such as the host server 110. In particular, the Secure Boot protocol defines a signature database (DB) for storing signers or image hashes of UEFI applications, software loaders, and UEFI device drivers that can be loaded on the computer during an initialization (boot) procedure. For example, the DB database can store a signature authorizing execution of an operating system loader, such as the Microsoft Boot Manager. The Secure Boot protocol also defines a revoked signatures database (DBX) for storing images that are no longer trusted and may not be loaded during a boot procedure. For example, a Secure Boot compliant BIOS is configured to execute a signed device driver only if the driver is identified in the DB database, and will refuse to execute the driver if the driver is identified in the DBX database. The Secure Boot protocol further defines a Platform Key (PK) and a Key Exchange Key (KEK). As used herein, the term Secure Boot protocol refers to operational features and requirements defined by the UEFI Secure Boot specification, and should not be confused with a UEFI protocol, which refers to a software interface used for communication between two binary modules.

Databases DB, DBX, PK, and KEK can be stored as authenticated UEFI non-volatile variables in the BIOS flash memory. For example, an original equipment manufacturer (OEM) can store the signature database, the revoked signatures database, and the KEK signature databases on the firmware nonvolatile random access memory (NVRAM) at manufacturing time. After firmware validation and testing, the OEM can lock the firmware and generates a Platform Key. The PK can be used to sign updates to the KEK or to turn off Secure Boot. After the computer is turned on, the signature databases are each checked against the PK. During power-on-self-test (POST), a LoadImage( ) function loads a UEFI image (UEFI executable) into memory and returns a handle to the image. When the UEFI Loadimage( ) function is called, Secure Boot authentication check code can be invoked to make sure the image is from a trusted source, for example the driver's certificate is included in the DB database and is not included in the DBX database. Microsoft Win8 logo requirement introduced two Secure Boot operating modes in BIOS Setup Options, Standard Mode and Custom Mode. In the Standard mode, the keys are pre-provisioned in the BIOS, for example by an OEM. Keys and certificates can only be added or deleted by signing the contents by previously trusted keys that are programmed in the BIOS, or by updating BIOS firmware that contains different keys. In the Custom mode more flexibility is added to allow a physically present user to modify the contents of the Secure Boot signature databases, the user can even turn off Secure Boot by deleting the PK. Systems and methods for managing Secure Boot signature databases and keys using a centralized key management server are disclosed herein.

FIG. 1 shows an information handling system 100 according to a specific embodiment of the present disclosure. System 100 includes a host server 110 that is coupled to a provisioning server 150 by a network 170. Host server 110 is representative of each of many servers installed at a data center. Host server 110 includes a service processor 120 and a basic input/output system (BIOS) 130. Service processor 120 can implement a key management server (KMS) client 122. Server 110 includes one or more data storage devices accessible by the BIOS 130. For example, server 110 can include a non-volatile memory (not explicitly shown at FIG. 1) that is configured to store BIOS firmware, configuration parameters, and the like. In particular, a non-volatile storage device can be configured to store signature databases and keys 140 defined by Secure Boot protocol promulgated by the Unified Extensible Firmware Interface (UEIF) specification, including Secure Boot databases PK, KEK, DB, and DBX. The host server 110 can include many other devices, not shown at FIG. 1, for example network interface controllers, memory devices, and the like. Provisioning server 150 includes, or has access to, one or more data storage devices configured to store a master set of Secure Boot signature databases and keys 160. The network 170 supports communication between provisioning server 150 and service processors 120.

Service processor 120 may also be referred to as a side-band processor, an out-of-band processor, a management controller, and the like. An example of a service processor is the integrated Dell Remote Access Controller (iDRAC). A service processor can be configured to interface with baseboard management controller (BMC) devices. A service processor can include a central processing unit, volatile and nonvolatile memory devices, a network interface controller (NIC), and the like. A service processor can perform many system management functions, including monitoring system status, performing diagnostic services, facilitating installation of device firmware and other device and server software, and the like. In an embodiment, a service processor is configured to operate independently of the state of a primary central processing unit (CPU) and independently of the state of an operating system (OS) installed at the CPU, referred to herein as out-of-band management. A service processor can include a unique Internet Protocol (IP) address and media access control (MAC) address to facilitate communication and interaction with the service processor.

A service processor can support one or more interface protocols to allow administrative personnel or other devices and processes to interact with the service processor. For example, a service processor can provide a graphical user interface (GUI) that displays system status and allows an administrator to configure operation of an associated server. Any operation that changes the configuration of a service processor is referred to herein as a transaction. There are many standardized interface protocols in use today, such as Command Line Interface (CLI), Open Manage Server Administrator (OMSA), Intelligent Platform Management Interface (IPMI), Remote Access Controller Administrator (RACDAM), Web Services-Management (WSMAN) and the like. Service processor 120 and provisioning server 150 of the information handling system 100 can operate in compliance with one or more of the standard protocols listed above, another standard protocol, or one or more proprietary protocols.

To the system BIOS 130, service processor 120 can be considered a trusted device that is protected during POST. Accordingly, service processor 120 can be utilized to transfer Secure Boot keys and certificates from provisioning server 150 to host server 110. In one embodiment, BIOS 130 can communicate with the service processor using secure IPMI commands over an IPMI data transfer channel using a Shared Memory Architecture (SMA) interface, Keyboard Controller Style (KCS) interface, or the like. Service processor 120 can implement a key management system, such as KMS 122, that can respond to commands received from provisioning server 150.

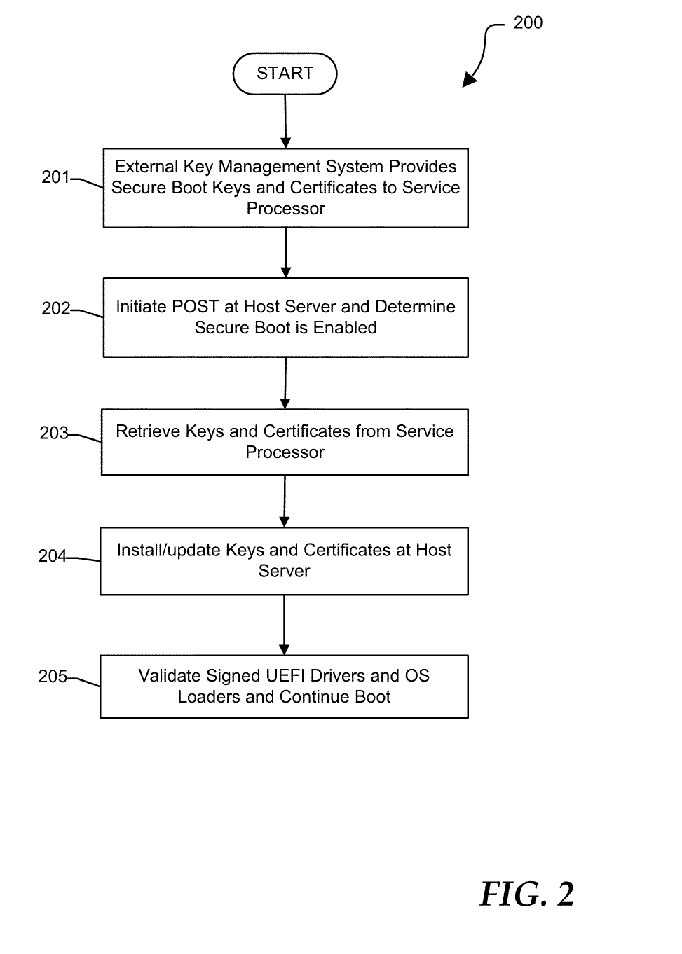

FIG. 2 shows a method 200 for provisioning Secure Boot keys and certificates to an information handling system according to a specific embodiment of the present disclosure. In particular, the method 200 illustrates an embodiment wherein the provisioning server 150 provides Secure Boot databases to service processor 120, and BIOS 130 can copy the databases to BIOS NVRAM when host server 110 is booted. The method 200 begins at block 201 where an external key management system provides Secure Boot keys and certificates to a service processor at an information handling system. For example, provisioning server 150 can utilize a KMS protocol to download Secure Boot databases PK, KEK, DB, and DBX to service processor 120, where they can be stored at a volatile or non-volatile memory device local to service processor 120. This transaction requires that service processor 120 is receiving auxiliary power; however it is not necessary that host server 110 is receiving power or is presently operational.

The method continues at block 202, where the host server is initialized and determines that Secure Boot is enabled. For example, at an early stage of a boot sequence at the host server 110, execution of intrinsic BIOS program code can be initialized. The boot process administered by BIOS 130 can be UEFI compliant, and typically includes a sequence of phases including a security (SEC) phase, a pre-EFI initialization (PEI) phase, a driver execution environment DXE) phase, a boot device selection (BDS) phase, a run time (RT) phase, and an after life (AF) phase. During an early portion of the DXE phase, BIOS 130 can determine that Secure Boot is enabled. The method continues at block 203 where BIOS 130 retrieves Secure Boot keys and certificates from the service processor. For example, BIOS 130 can execute secure IPMI commands over an interface at service processor 120 to fetch the Secure Boot databases PK, KEK, DB, and DBX from the memory device at service processor 120.

The method continues at block 204 where the Secure Boot databases are installed or updated at the host server. For example, the Secure Boot databases PK, KEK, DB, and DBX retrieved from service processor can be stored at databases 140 at the host system BIOS NVRAM. In an embodiment, if the BIOS NVRAM presently includes Secure Boot databases, the BIOS can compare the existing databases with the keys and certificates received from service processor 120. If the databases are the same, the BIOS can continue using the existing databases 140. Otherwise, the BIOS can update the databases 140, for example, adding certificates to the DB database, and revoking existing certificates by placing them in the DBX database. The method continues at block 205 where signed UEFI drivers and OS loaders are validated using Secure Boot keys and certificates stored at the BIOS NVRAM.

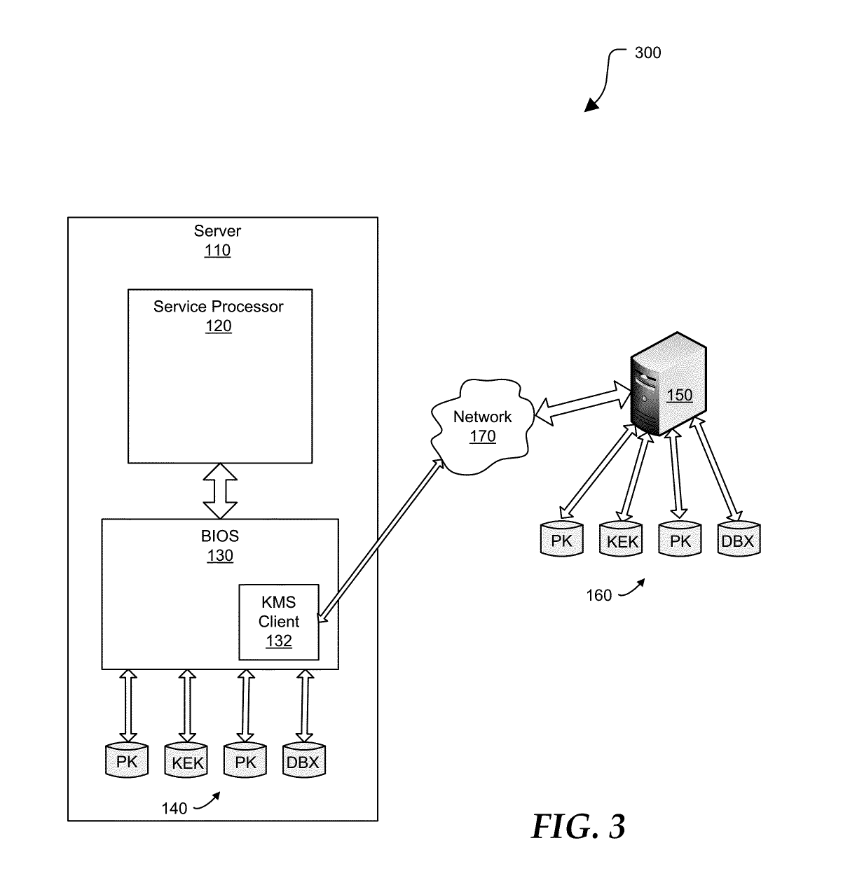

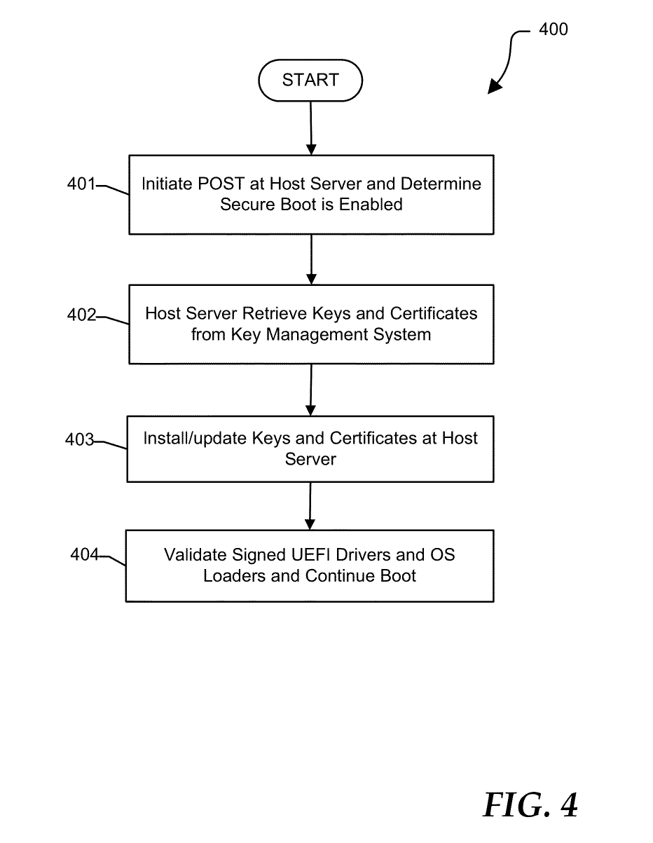

FIG. 3 shows an information handling system 300 according to another embodiment of the present disclosure. System 300 is configured to retrieve or access Secure Boot databases directly from provisioning server 150. The system 300 is similar to system 100 of FIG. 1, and includes host server 110 that is coupled to provisioning server 150 by network 170. The host server 110 includes service processor 120 and BIOS 130. BIOS 130 can implement a KMS client 132, similar to KMS client 122 of system 100. Server 110 includes one or more data storage devices accessible by BIOS 130 for storing firmware and other system information, including Secure Boot databases 140. Provisioning server 150 includes, or has access to, one or more data storage devices configured to store a master set of Secure Boot signature databases and keys 160. The operation of system 300 can be better understood with reference to FIG. 4. In an embodiment, the provisioning server 150 can provide centralized operating system mode key databases, such as a Machine Owner Keys (MOK) database.

FIG. 4 shows a method 400 for provisioning Secure Boot keys and certificates to an information handling system according to another embodiment of the present disclosure. The method 400 begins at block 401 where POST is initiated at a host server and it is determined that Secure Boot in enabled. The method continues at block 402 where the host server retrieves Secure Boot keys and certificates from a key management system. For example, intrinsic BIOS code can utilize KMS client 132, or another communications protocol, to establish a secure communication channel with provisioning server 150. For example, BIOS 130 can retrieve Secure Boot databases PK, KEK, DB, and DBX from server 150. The method continues at block 403 where the retrieved Secure Boot keys and certificates are installed at the host server, or existing databases are updated. For example, BIOS 130 can store the retrieved databases at Secure Boot databases 140 located at BIOS NVRAM. The method continues at block 404 where signed UEFI drivers and OS loaders are validated using Secure Boot keys and certificates stored at the BIOS NVRAM.

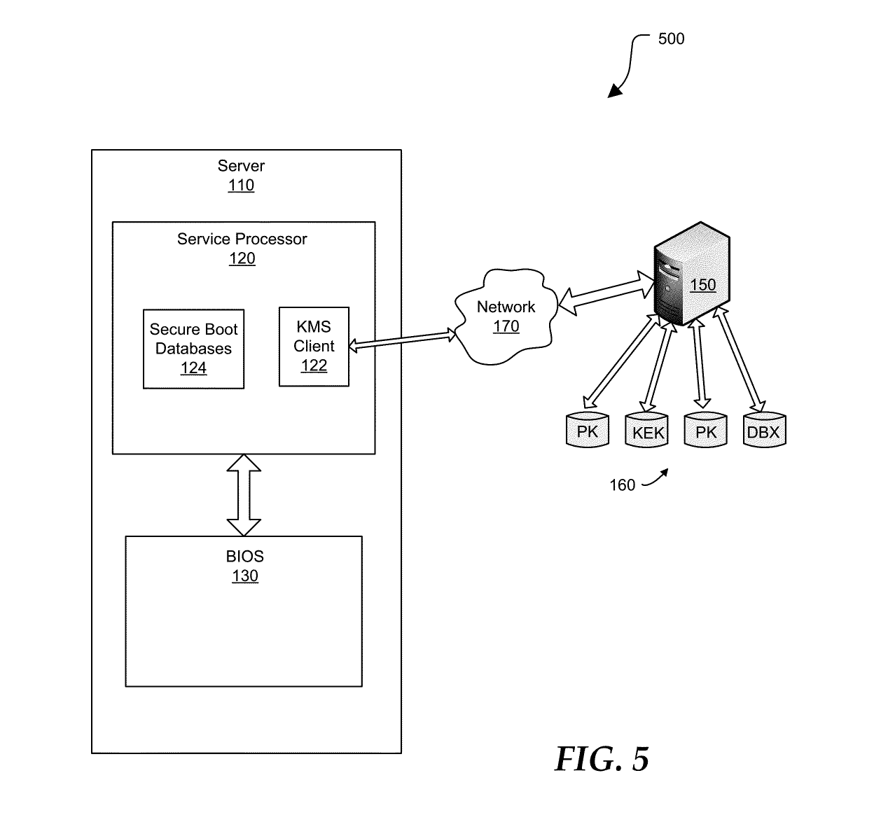

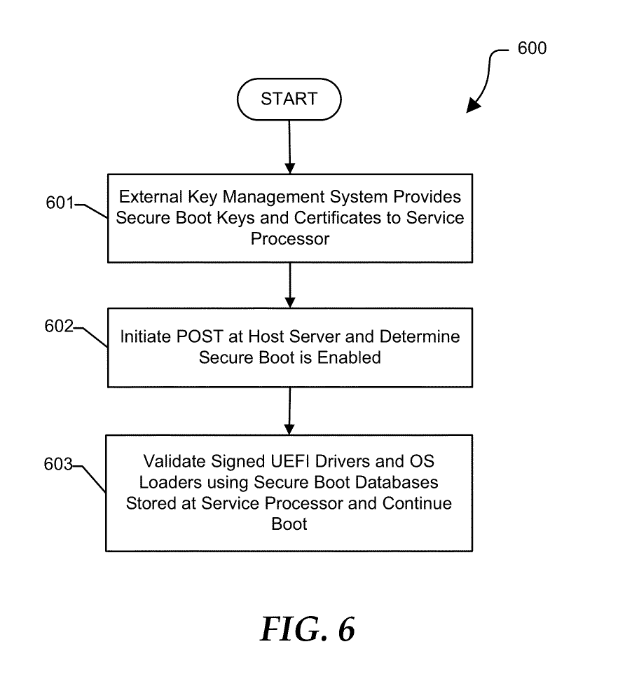

FIG. 5 shows an information handling system 500 according to still another embodiment of the present disclosure. System 500 is configured to access Secure Boot databases directly from service processor 120. Accordingly, the Secure Boot databases are not copied to BIOS NVRAM. Instead, driver and loader validation is performed using Secure Boot databases located at service processor 120. System 500 is similar to system 100 of FIG. 1, and includes host server 110 that is coupled to provisioning server 150 by network 170. Host server 110 includes service processor 120 and basic input/output system (BIOS) 130. Service processor 120 includes one or more storage devices for storing Secure Boot databases 124, including Secure Boot databases PK, KEK, DB, and DBX. Service processor 120 can implement key management server (KMS) client 122. Provisioning server 150 includes, or has access to, one or more data storage devices configured to store a master set of Secure Boot signature databases and keys 160. The network 170 supports communication between provisioning server 150 and service processors 120. The operation of system 500 can be better understood with reference to FIG. 6.

FIG. 6 shows a method 600 for provisioning Secure Boot keys and certificates to an information handling system according to still another embodiment of the present disclosure. The method 600 begins at block 601 where an external key management system provides Secure Boot keys and certificates to a service processor at an information handling system. For example, provisioning server 150 can utilize a KMS protocol to download Secure Boot databases PK, KEK, DB, and DBX to service processor 120, where they can be stored at a volatile or non-volatile memory device local to service processor 120, providing Secure Boot databases 124. This transaction requires that service processor 120 is receiving auxiliary power; however it is not necessary that host server 110 is receiving power or is presently operational. The method continues at block 602, where the host server is initialized and determines that Secure Boot is enabled. For example, at an early stage of a boot sequence at the host server 110, execution of intrinsic BIOS program code can be initialized. The method continues at block 603 where signed UEFI drivers and OS loaders are validated using Secure Boot databases stored at a service processor. For example, BIOS 130 can access Secure Boot databases 124 at service processor 120 to validate drivers and loaders during the boot process of host server 110 configured by BIOS 130.

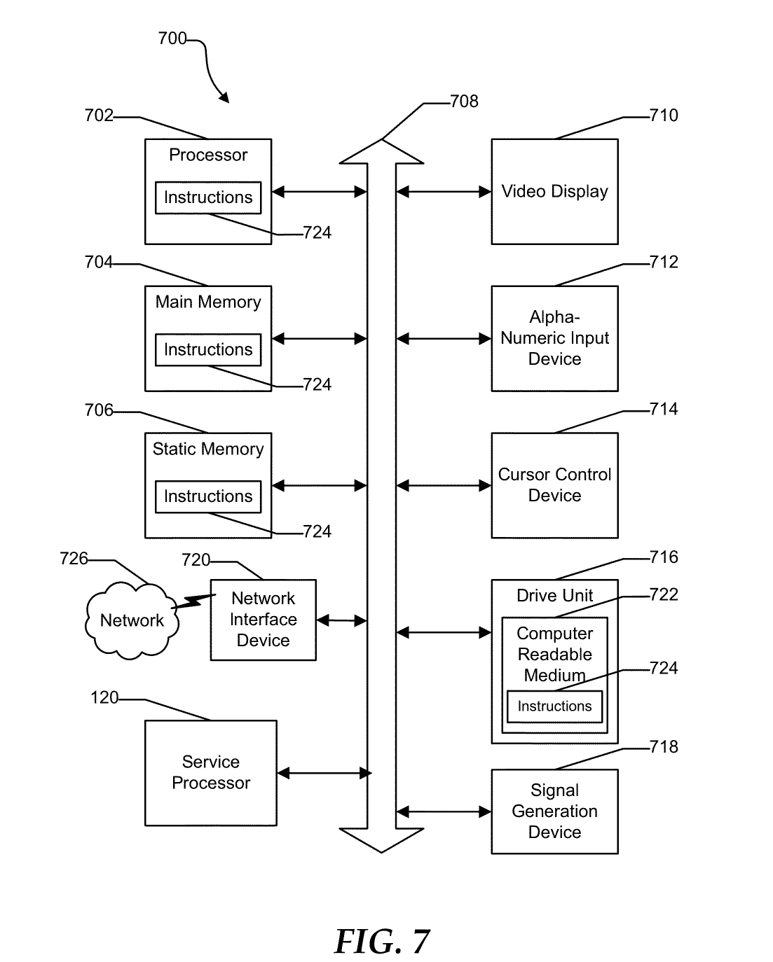

FIG. 7 shows an information handling system 700 capable of administering each of the specific embodiments of the present disclosure. The information handling system 700 can represent servers included at the information handling system 100 of FIG. 1. The information handling system 700 may include a processor 702 such as a central processing unit (CPU), a graphics processing unit (GPU), or both. Moreover, the information handling system 700 can include a main memory 704 and a static memory 706 that can communicate with each other via a bus 708. As shown, the information handling system 700 may further include a video display unit 710, such as a liquid crystal display (LCD), an organic light emitting diode (OLED), a flat panel display, a solid state display, or a cathode ray tube (CRT). Additionally, the information handling system 700 may include an input device 712, such as a keyboard, and a cursor control device 714, such as a mouse. The information handling system 700 can also include a disk drive unit 716, a signal generation device 718, such as a speaker or remote control, and a network interface device 720. The information handling system 700 can include service processor 120, described above. The information handling system 700 can represent a server device whose resources can be shared by multiple client devices, or it can represent an individual client device, such as a desktop personal computer.

The information handling system 700 can include a set of instructions that can be executed to cause the computer system to perform any one or more of the methods or computer based functions disclosed herein. The computer system 700 may operate as a standalone device or may be connected such as using a network, to other computer systems or peripheral devices.

In a networked deployment, the information handling system 700 may operate in the capacity of a server or as a client user computer in a server-client user network environment, or as a peer computer system in a peer-to-peer (or distributed) network environment. The information handling system 700 can also be implemented as or incorporated into various devices, such as a personal computer (PC), a tablet PC, a set-top box (STB), a PDA, a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 700 can be implemented using electronic devices that provide voice, video or data communication. Further, while a single information handling system 700 is illustrated, the term “system” shall also be taken to include any collection of systems or sub-systems that individually or jointly execute a set, or multiple sets, of instructions to perform one or more computer functions.

The disk drive unit 716 may include a computer-readable medium 722 in which one or more sets of instructions 724 such as software can be embedded. Further, the instructions 724 may embody one or more of the methods or logic as described herein. In a particular embodiment, the instructions 724 may reside completely, or at least partially, within the main memory 704, the static memory 706, and/or within the processor 702 during execution by the information handling system 700. The main memory 704 and the processor 702 also may include computer-readable media. The network interface device 720 can provide connectivity to a network 726, e.g., a wide area network (WAN), a local area network (LAN), or other network.

In an alternative embodiment, dedicated hardware implementations such as application specific integrated circuits, programmable logic arrays and other hardware devices can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 724 or receives and executes instructions 724 responsive to a propagated signal; so that a device connected to a network 726 can communicate voice, video or data over the network 726. Further, the instructions 724 may be transmitted or received over the network 726 via the network interface device 720.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding, or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to store information received via carrier wave signals such as a signal communicated over a transmission medium. Furthermore, a computer readable medium can store information received from distributed network resources such as from a cloud-based environment. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although only a few exemplary embodiments have been described in detail above, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

What is claimed is:

1. A method comprising:
receiving at a service processor of an information handling system a Secure Boot database, the database provided by a provisioning server coupled to the service processor by a data communication network;
storing the Secure Boot database at a memory device included at the service processor; and
providing the Secure Boot database to a basic input output system (BIOS) at the information handling system in response to a request issued by intrinsic BIOS instructions executed during initialization of the information handling system.

2. The method of claim 1, wherein the Secure Boot database include a DB database, a DBX database, a PK database, and a KEK database.

3. The method of claim 1, further comprising validating device drivers included at the information handling system based on the Secure Boot database provided by the service processor.

4. The method of claim 1, wherein the receiving comprises receiving the Secure Boot database using a secure sockets layer protocol administered by a software client executing at the service processor.

5. The method of claim 1, wherein a master copy of the Secure Boot database is maintained at the provisioning server, and wherein the receiving further comprises receiving the Secure Boot database in response to a request initiated by the provisioning server.

6. The method of claim 1, further comprising updating the database at the BIOS memory in response to determining at the BIOS the Secure Boot database provided by the service processor include information different from a database presently stored at a BIOS memory.

7. The method of claim 1, wherein the receiving comprises receiving the Secure Boot database prior to a boot event at the information handling system.

8. A method comprising:
maintaining a Secure Boot database at a provisioning server coupled by a data communication network to a service processor included at a first information handling system; and
providing the Secure Boot database to the service processor for storage at a memory device included at the service processor.

9. The method of claim 8, further comprising providing the Secure Boot database to the information handling system for storage at a basic input output system (BIOS) firmware memory device in response to execution of intrinsic firmware instructions.

10. The method of claim 8, wherein the Secure Boot database include a DB database, a DBX database, a PK database, and a KEK database.

11. The method of claim 8, further comprising validating device drivers included at the information handling system based on the Secure Boot database provided by the service processor.

12. The method of claim 8, wherein the providing further comprises providing the Secure Boot database using a secure sockets layer protocol administered by a software client executing at the service processor.

13. The method of claim 8, wherein the providing comprises providing the Secure Boot database prior to a boot event at the information handling system.

14. An information handling system comprising:
a provisioning server to store a Secure Boot signature database; and
a host server including a service processor, the service processor coupled to the provisioning server by a data communication network;
wherein the service processor is configured to:
receive the Secure Boot database from the provisioning server;
store the Secure Boot database at a memory device included at the service processor; and
provide the Secure Boot databases to a basic input output system (BIOS) at the host server in response to a request issued by intrinsic BIOS instructions executed during initialization of the host server.

15. The information handling system of claim 13, wherein the host server is configured to validate device drivers included at the information handling system based on the Secure Boot database provided by the service processor.

16. The information handling system of claim 13, wherein the receiving comprises receiving the Secure Boot databases using a secure sockets layer protocol administered by a software client executing at the service processor.

17. The information handling system of claim 13, wherein a master copy of the Secure Boot database is maintained at the provisioning server, and wherein the receiving further comprises receiving the Secure Boot database in response to a request initiated by the provisioning server.

18. The information handling system of claim 13, further comprising updating the databases at the BIOS memory in response to determining at the BIOS the Secure Boot database provided by the service processor include information different from a database currently stored at a BIOS memory.

19. The information handling system of claim 13, wherein the receiving comprises receiving the Secure Boot databases prior to a boot event at the information handling system.

20. The information handling system of claim 13, wherein the host processor further includes a BIOS firmware memory device and the host processor is configured to request the Secure Boot database from the provisioning server for storage at the BIOS firmware memory device in response to execution of intrinsic firmware instructions.
